(19) United States
(12) Patent Application Publication
(10) Pub. No.: US 2009/0122703 A1
(43) Pub. Date: May 14, 2009

(54) Electronic Device and Method for Flow Control

(75) Inventors: Om Prakash Gangwal, Eindhoven (NL); Andrei Radulescu, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,034

(22) PCT Filed: Apr. 3, 2006
(86) PCT No.: PCT/IB2006/051002

§ 371 Date: Oct. 9, 2007

(30) Foreign Application Priority Data
Apr. 13, 2005 (EP) 05102914.8

(51) Int. Cl. H04J 1/16

(52) U.S. Cl. 370/235

(57) ABSTRACT

An electronic device is provided comprising a plurality of processing units (IP; MIP, SIP); an interconnect means (NOC) for coupling the plurality of processing units (IP; MIP, SIP); and a plurality of interia.ee means (NI; MNI, SNI) arranged between one of the processing units (IP; MIP, SIP) and the interconnect means (NOC), for enabling a communication between the processing units (IP; MIP, SIP) and the interconnect means. The communication between the processing units (IP; MIP, SIP) is a packet-based communication via the interface means (NI; MNI, SNI) and the interconnect means (NOC). Each packet first comprises a first header (H) followed by a pay load (P). Said interface means comprise (NI; MNI, SNI) a flow control means (FCM) for controlling the communication flow between two processing units (IP; MIP, SIP) based on flow control credit information (C), for inserting the first header (H) in each packet, and for additionally inserting a second header (H) into a packet according to an amount of required flow control credit information (C).

The present invention relates to an electronic device as well as to a method for flow control within an electronic device.

Networks on chip NOC proved to be scalable interconnect structures which could become possible solutions for future on chip interconnections between so-called IP blocks, i.e. intellectual property blocks. IP blocks are usually modules on chip with a specific function like CPUs, memories, digital signal processors or the like. The IP blocks communicate with each other via the network on chip. The network on chip is typically composed of network interfaces and routers. The network interfaces serve to provide an interface between the IP block and the network on chip, i.e. they translate the information from the IP block to information which the network on chip can understand and vice versa. The routers serve to transport data from one network interface to another. For best effort communication, there is no guarantee regarding the latency of the throughput of the communication. For guaranteed throughput services, an exact value for the latency and throughput is required.

The communication within a network on chip NOC is packet-based, i.e. the packets are forwarded between the routers or between routers and network interfaces. A packet typically consists of a header and payload. As the network interface serves to translate information from the IP block to the network on chip, a network interface typically performs some sort of buffering in order to hide round chip latency as well as rate differences between the producer/consumer (IP block) and network. In “An Efficient On-Chip NI Offering Guaranteed Services, Shared-Memory Abstraction, and Flexible Network Configuration”, by Andrei R\check{a}dulescu et al., IEEE transactions on computer-aided design of integrated circuits and systems, volume 24, No. 1, January 2005, an implementation of a flow control mechanism based on credits in order to avoid an overflow of buffers in a network interface is described. A consumer network interface sends credits to the producer network interface when the consumer removes data from the consuming network interface. The credit value indicates the amount of data consumed by the consumer after a previous credit was sent. A limited number of bits is reserved to forward the credit information and is typically piggybacked to the packet header.

It is an object of the invention to provide an electronic device as well as a method for flow control with an improved and more efficient flow control.

This object is solved by an electronic device according to claim 1 as well as by a method for flow control according to claim 6.

Therefore, an electronic device is provided comprising a plurality of processing units, an interconnect means for coupling the plurality of processing units, and a plurality of interface means, arranged between one of the processing units and the interconnect means, for enabling a communication between the processing units and the interconnect means. The communication between the processing units is a packet-based communication via the interface means and the interconnect means. Each packet first comprises a first header followed by a payload. Said interface means comprise a flow control means for controlling the communication flow between two processing units based on flow control credit information, for inserting the first header in each packet, and for additionally inserting a second header into a packet according to an amount of required flow control credit information.

Accordingly, more credit information can be inserted into the communication if required, such that sufficient credit information can be introduced.

According to an aspect of the invention the flow control means can insert the second header at pre-defined positions such that a static implementation of the flow control is achieved.

According to an aspect of the invention the interface means comprises a slot table with flow control information, wherein the flow control means is adapted to insert the second header according to the flow control information stored in the slot table.

According to an aspect of the invention the flow control means is adapted to insert the second header if the flow control credit information exceed a pre-defined value. Accordingly, the flow control is performed dynamically and can better match the actual requirements of the communication.

The invention also relates to a method for flow control in an electronic device having a plurality of processing units; an interconnect means for coupling the plurality of processing units; and a plurality of interface means arranged between one of the processing units; and the interconnect means, for enabling a communication between the processing units and the interconnect means. The communication between the processing units is a packet-based communication via the interface means and the interconnect means. Each packet first comprises a first header followed by a payload. The communication flow between two processing units is controlled based on flow control credit information. The first header is inserted in each packet. Additionally, a second header is inserted according to an amount of required flow control credit information.

The invention is based on the idea to introduce additional redundant headers into a communication via the network on chip, wherein the additional headers are used to carry flow control credit information.

These and other aspects of the invention are apparent from and will be elucidated with reference to the embodiments described hereinafter and with respect to the following figures.

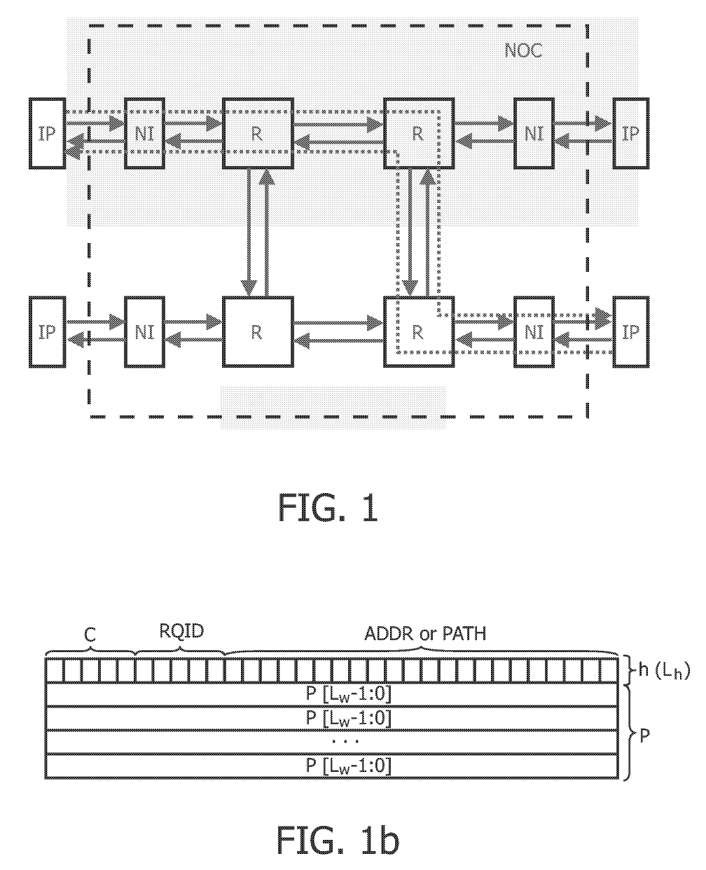

FIG. 1a shows a basic architecture of a network on chip according to a first embodiment;

FIG. 1b shows a schematic representation of the structure of a packet;

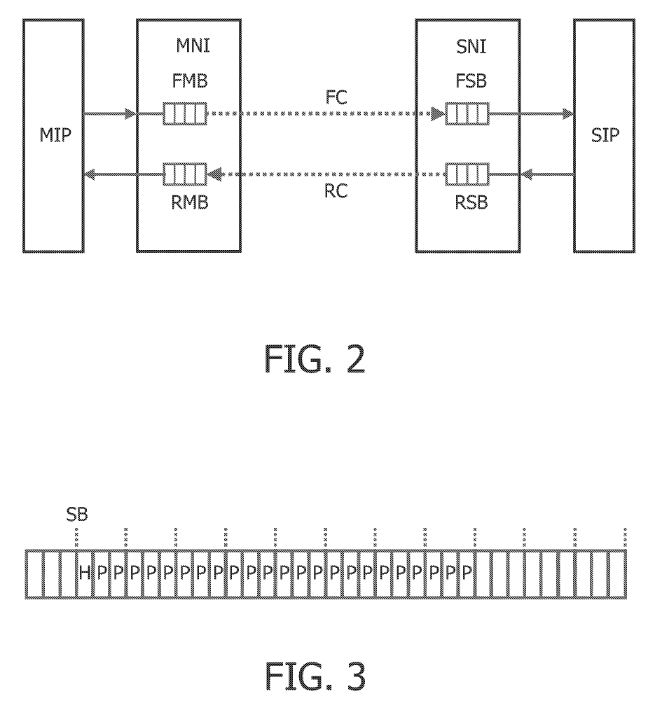

FIG. 2 shows a schematic presentation of part of the network on chip according to FIG. 1a;

FIG. 3 shows an example of a contiguous slot allocation for a network on chip according to FIG. 1a;

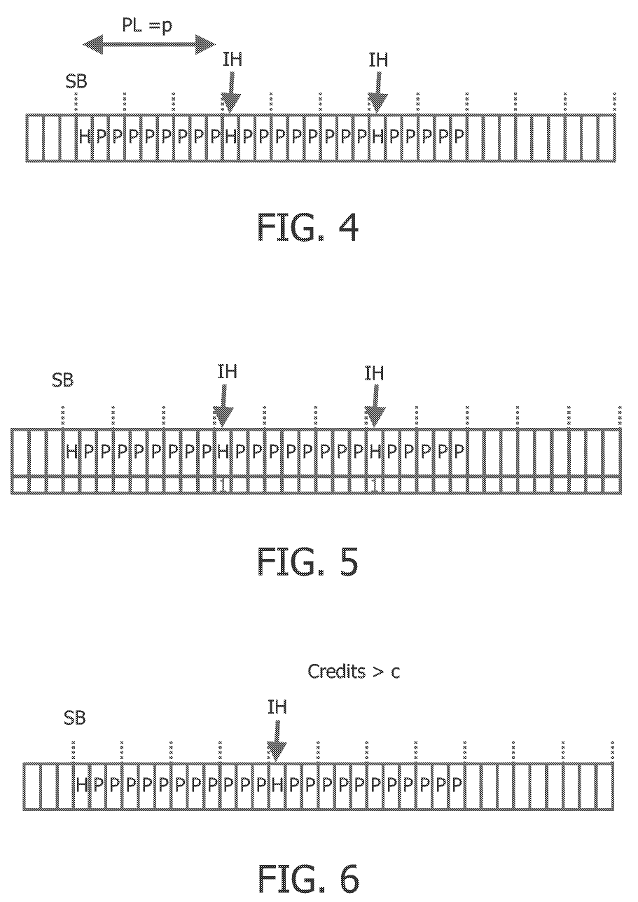

FIG. 4 shows a representation of a contiguous slot allocation for a network on chip according to FIG. 1a according to a first embodiment;

FIG. 5 shows a representation of a contiguous slot allocation for a network on chip according to FIG. 1a according to a second embodiment:

FIG. 6 shows a representation of a slot allocation for a network on chip according to FIG. 1a according to the third embodiment;

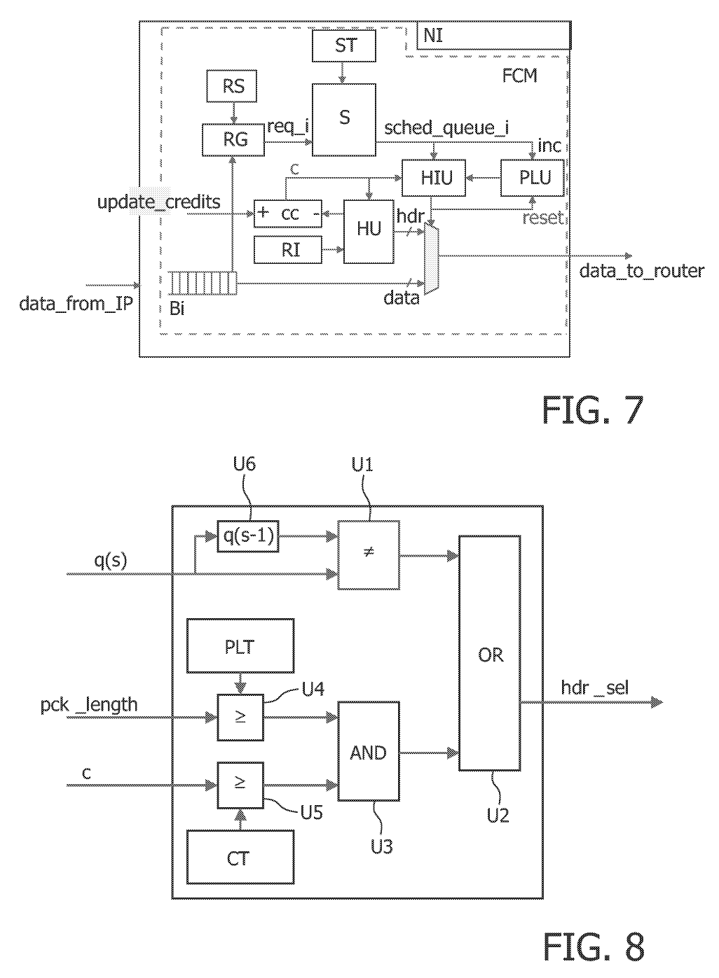

FIG. 7 shows a basic architecture of a network interface; and

FIG. 8 shows a block diagram of a header insertion unit for a network interface according to FIG. 7.

FIG. 1a shows a basic structure of a system on chip with a network on chip interconnect according to a first embodiment. A plurality of IP blocks IP are coupled to each other via a network on chip NOC. The network NOC comprises network interfaces NI for providing an interface between the IP block IP and the network on chip NOC. The network on chip NOC furthermore comprises a plurality of routers R. The network interface NI serves to translate the information from the IP block to a protocol, which can be handled by the network on chip NOC and vice versa. The routers R serve to transport the data from one network interface NI to another. The communication between the network interfaces NI will not only depend on the number of routers R in between them, but also on the topology of the routers R. The routers R may be fully connected, connected in a 2D mesh, connected in a linear array, connected in a torus, connected in a folded torus, connected in a binary tree or in a fat-tree fashion. The IP block IP can be implemented as modules on chip with a specific or dedicated function such as CPU, memory, digital signal processors or the like.

The information from the IP block IP that is transferred via the network on chip NOC will be translated at the network interface NI into packets with variable length. The information from the IP block IP will typically comprise a command followed by an address and an actual data to be transported over the network. The network interface NI will divide the information from the IP block IP into pieces called packets and will add a packet header to each of the packets. Such a packet header comprises extra information that allows the transmission of the data over the network (e.g. destination address or routing path, and flow control information). Accordingly, each packet is divided into flits (flow control digit), which can travel through the network on chip. The flit can be seen as the smallest granularity at which control is taken place. An end-to-end flow control is necessary to ensure that data is not send unless there is sufficient space available in the destination buffer.

FIG. 1b shows a schematic representation of a packet used for the communication in a network on chip according to FIG. 1a. Each packet comprises a header h followed by some payload P. To improve the efficiency of the flow control, credits C are introduced and are piggybacked in the header h of the packets. Accordingly, a packet header typically comprises routing information like the path and queue identifier and additionally a number of bits is reserved for sending credit information. If for example five bits are used to send the credit information, the maximum amount of credits that can be sent at a single time is 2⁵=32.

FIG. 2 shows a block diagram of part of the network on chip according to FIG. 1a. In particular, an IP block acting as master MIP with its associated master network interface MIP and an IP block acting as slave SIP with its associated slave network interface is shown. The communication between the IP block MIP and the IP block SIP is performed via a connection with two associated channels and the respective buffers. The routers in between are omitted merely for illustrative purpose. The two channels include a forward channel FC from the master network interface MIP to the slave network interface SIP as well as a reverse channel RC from the slave network interface SNI to the master network interface MNI. The master network interface MIP comprises a forward master buffer FMB and a reverse master buffer RnM. The slave network interface comprises a forward slave buffer FSB and a reverse slave buffer RSB. In order to avoid an overflow of the buffers in the network interfaces, some kind of flow control mechanism is to be implemented. The flow control mechanism according to the first embodiment is based on credit information. The consumer network interface will send credits to the producer network interface when a consumer has removed data from the consumer network interface. The actual credit value indicates the amount of data consumed by the consumer after a previous credit was sent. Preferably, a number of bits is reserved to send the credit information and can be piggybacked to a packet header for efficiency reasons as shown in FIG. 1b.

FIG. 3 shows a representation of a contiguous slot allocation for a network interface according to FIG. 1a. A guaranteed throughput connection is based on a time division multiple access TDMA scheme, wherein a slot table divides the available bandwidth into slots. An amount of bandwidth can be reserved for a particular connection by reserving a specific number of slots in the slot table for the connection. Data from a specific connection can only be forwarded within the allocated number of slots. If the allocated number of slots has been consumed, the connection has to wait for further slots. Within a connection, a contiguous block of slots defines the particular size of a packet. At the start of such a contiguous block or number of slots (a slot boundary SB), a header H is inserted while the rest of the words can be considered as payload P.

If all slots for a connection are allocated contiguously, only one header H will be send in an iteration of the slot table with a maximum value of c words. For a given size of a slot table and time needed to move one slot to another, the header rate will be 1/(slot_table_size*slot_duration). If a credit value of c words is sent per header, the rate of credit in terms of words is (header_rate*c) words per second. However, if the credit data rate is less than the consumer data rate, then an unstable system will be resulted.

FIG. 4 shows a representation of a slot allocation according to the first embodiment. If the data rate of the credit information is less than the consumer data rate, then the system can be unstable and the credit data rate has to be increased. This is performed by inserting more headers H than actually required to indicate the slot boundaries SB. In other words, redundant headers are inserted. This is preferably performed automatically in the reverse channel RC in order to allow the forwarding of credit information. The automatic insertion of new headers can be performed statically or dynamically. In FIG. 4, a static implementation of the insertion of redundant additional headers is shown. The insertion of additional headers according to the first embodiment is fixed in priority and can be indicated by a fixed packet length PL. A fixed packet length in terms of a number of words or a number of slots requires the insertion of a header at the multiple of the packet length within a contiguous block of slots. Here, the packet length must be determined such that sufficient headers H are present in order to send the credit information.

FIG. 5 shows a representation of a slot allocation according to a second embodiment. The second embodiment is also based on a static insertion of additional redundant headers H. Here, the headers are inserted by introducing an additional bit in the slot table. A network interface NI can inspect these additional bits in the slot table and insert a header accordingly to allow the sending of additional credit information.

FIG. 6 shows a representation of a slot table allocation according to the third embodiment. The header insertion according to the third embodiment is performed dynamically, i.e. a header is created when the credit values which need to be forwarded reaches a predefined threshold value, i.e. c. Accordingly, packets of varying length are created within a contiguous block of slots. Such a scheme will result in a minimum number of required headers in order to ensure the flow control rate.

Any combination of the first, second and third embodiment is possible. A network interface can for example insert a header if one or both conditions are present. In other words, the number of contiguous slots crosses or becomes equal to a fixed packet length or the credit values crosses a predefined credit value.

By choosing a lower predefined value or a short packet length, the amount of buffering required at the consumer side is lowered at the cost of sending additional headers H. If these values are programmable, a respective trade-off can be performed. Even more programmability and flexibility can be introduced by choosing these values for each of the channels FC, RC separately.

Although the concept of inserting additional redundant headers in order to send additional credit information is described with regard to a guaranteed throughput connection, the header insertion according to the first, second and third embodiment may also be applied to a best effort connection.

FIG. 7 shows a block diagram of a network interface. The network interface NI comprises a flow control means FCM having an input queue Bi, a remote space register RS, a request generator RG, a routing information register RI, a credit counter CC, a slot table ST, a scheduler S, a header unit HU, a header insertion unit HIU as well as a packet length unit PLU. The input queue Bi is used to receive data from an IP block IP. Routing information like the addresses is stored in a configurable routing information register RI. The credit counter CC is incremented when data is consumed in the output queue and is decremented when new headers are sent with credit value incorporated in the headers. The routing information from the routing information register RI as well as the value of the credit counter CC is forwarded to the header unit HU and form part of the header H. A request generator RG generates a request for the queue to send data based on the queue filling and the remote space as stored in the remote space register. The request for all queues is input to the scheduler S for selecting the next queue. This can be performed by the scheduler also based on information from the slot table ST. As soon as one of the queues is selected, the header insertion unit HUI decides whether an additional redundant header needs to be inserted. A header is inserted if the current slot is the first in a succession as a header is required. A (redundant) header is inserted if a condition for an extra header insertion is met. Such a condition may be if the packet length and/or the credits to be sent are above a threshold value.

FIG. 8 shows a block diagram of a header insertion unit of FIG. 7. The header insertion unit HIU is used to decide whether a header H is to be inserted. The header insertion unit HIU receives a signal q(s) for selecting the current queue in a slot S. q(s)=1 if a queue is selected in the slot S. A unit U6 is used to determine the queue q(s−1) in a previous slot. The signal q(s) and the signal q(s−1) are input to a unit U1, which serves to determine whether the two inputs are equal or not. If the signal q(s) and the signal q(s−1) are different, a new packet is started and a new header must be inserted.

The header insertion unit HIU also receives the packet length pck_length as well as the current value of the credit C. These two values are compared to pre-stored threshold values in the unit U4 and U5, respectively. In other words, the packet lengths is compared to a packet length threshold PLT and the current credit is compared to a credit threshold CT. The outputs of the unit U4 and U5 are input to a AND unit U3, i.e. if the packet length as well as the credit value is above the respective threshold, a new additional and redundant header is inserted. Preferably, the header insertion is only allowed in the first word of a multi-word flit.

The insertion of additional flow control headers is automatically taken care by the network interface such that any IP block does not have to take care of such a function. A trade-off between the buffer size and the number of headers per channel can be performed.

In other words, an additional redundant header can be inserted if the value of the packet length is above a threshold value, and/or if the current credit value is above a credit threshold. Additionally or alternatively, the insertion of an additional redundant header can be performed according to the presence of an additional bit in the slot table. The usage of an additional bit in the slot table has the advantage that the unit U1 is not required.

The invention may also be implemented by a data processing system based on a single chip or on multiple chips. The data processing system may comprise a single or multiple above-mentioned electronic devices.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim in numerating several means, several of these means can be embodied by one and the same item of hardware. The mere fact that certain measures are resided in mutually different dependent claims does not indicate that a combination of these measures cannot be used to advantage.

Furthermore, any reference signs in the claims shall not be constitute as limiting the scope of the claims.

1. Electronic device, comprising
a plurality of processing units (IP; MIP, SIP);
an interconnect means (NOC) for coupling the plurality of processing units (IP; MIP, SIP);
a plurality of interface means (NI; MNI, SNI) arranged between one of the processing units (IP; MIP, SIP) and the interconnect means (NOC), for enabling a communication between the processing units (IP; MIP, SIP) and the interconnect means;
wherein the communication between the processing units (IP; MIP, SIP) is a packet-based communication via the interface means (NI; MNI, SNI) and the interconnect means (NOC);
wherein each packet first comprises a first header (H) followed by a payload (P);
wherein said interface means comprise (NI; MNI, SNI) a flow control means (FCM) for controlling the communication flow between two processing units (IP; MIP, SIP) based on flow control credit information (C), for inserting the first header (H) in each packet, and for additionally inserting a second header (H) into a packet according to an amount of required flow control credit information (C).

2. Electronic device according to claim 1, wherein the flow control means (FCM) is adapted to insert the second header (H) at pre-defined positions.

3. Electronic device according to claim 1, wherein the interface means (NI; MNI, SNI) comprises a slot table (ST) with flow control information, wherein the flow control means (FCM) is adapted to insert the second header (H) according to the flow control information stored in the slot table (ST).

4. Electronic device according to claim 1, wherein the flow control means (FCM) is adapted to insert the second header (H) if the flow control credit information exceed a pre-defined value (CT; PLT).

5. Electronic device according to claim 1, wherein the flow control means (FCM) is adapted to insert the second header (H) at pre-defined positions; to insert the second header (H) according to the flow control information stored in a slot table (ST) which is arranged in the interface means; and/or to insert the second header (H) if the flow control credit information exceed a pre-defined value (CT; PLT).

6. Method for flow control in an electronic device having a plurality of processing units (IP; MIP, SIP); an interconnect means (NOC) for coupling the plurality of processing units (IP; MIP, SIP); and a plurality of interface means (NI; MNI, SNI) arranged between one of the processing units (IP; MIP, SIP) and the interconnect means (NOC), for enabling a communication between the processing units (IP; MIP, SIP) and the interconnect means;
wherein the communication between the processing units (IP; MIP, SIP) is a packet-based communication via the interface means (NI; MNI, SNI) and the interconnect means (NOC);
wherein each packet first comprises a first header (H) followed by a payload (P);
said method comprising the steps of:
controlling the communication flow between two processing units (IP; MIP, SIP) based on flow control credit information (C);
inserting the first header (H) in each packet, and
additionally inserting a second header (H) into a packet according to an amount of required flow control credit information (C).
